(19) United States
(12) Patent Application Publication
(10) Pub. No.: US 2018/0326771 A1
(43) Pub. Date: Nov. 15, 2018

(54) A METHOD TO PRINT DURABLE AND HIGH CONTRAST IDENTIFICATION CODES, INDICIA AND/OR FIGURES ON AN ANIMAL TAG

(71) Applicant: Via ai Prati, Bedano (CH)

(72) Inventors: Vickie Aboutanos, Lugano (CH); Damien PACHOUD, Pregassona (CH)

(21) Appl. No.: 15/757,869

(22) PCT Filed: Sep. 7, 2015
(86) PCT No.: PCT/EP2015/070412

§ 371 Date: Mar. 6, 2018

(51) Int. Cl. B41M 5/00; B41M 7/00; A01K 11/00; C09D 11/101; C09D 11/324; C09D 11/322

(52) U.S. Cl. CPC B41M 5/0064; B41M 5/0047; B41M 7/0081; C09D 11/322; C09D 11/101; C09D 11/324; A01K 11/001

(57) ABSTRACT

It is disclosed a method to print durable and high contrast identification codes, indicia and figures on an animal tag. The method is characterized by printing an ink on a polymeric substrate of the animal tag, the step of printing being executed with inkjet printing technique and the ink being a UV-curable ink including pigments, wherein the ink is UV cured after inkjet printing, to become integral part of the polymeric substrate.

### FIELD OF APPLICATION

The present invention relates to an animal tag including identification codes, indicia and/or figures or barcodes to identify an animal. More particularly, the invention relates to an animal tag, made of polymeric material, of the type cited above, wherein the identification codes, indicia or figures are printed on the polymeric substrate and are adapted to be read by a human operator at a long distance.

The invention also relates to a method to print identification codes, indicia and/or figures on an animal tag.

### PRIOR ART

Animal tags including a plastic substrate carrying identification codes, indicia and/or figures adapted to be applied to the animal, for instance to the ear of the animal, and to be read by a human operator at a distance from the animal are known.

Polymeric animal tags designed to be applied to the animals' ear are the most used tags for identification (ID) in livestock. Other tags include leg bands, neck tags and/or boluses which are not pierced into the body of the animal.

In all the tags mentioned above, the identification can take various forms, from simple numerical indicia to more elaborate coding, where usually each animal is allocated a unique identification code. For instance, plastic tags used in a small farm may be simply marked with by a black ink marker as farmers could reuse these tags. On the contrary, for official country programs and other large-scale industrial farm management where meat and milk traceability is required, each animal must have a unique tamper proof code.

The tags may be only visual tags, where a farm number, for instance in the form of three or four digits and/or a farm name, is printed on the tag. They can also be combined with a machine readable code, for instance a linear one dimensional barcode or two dimensional data matrix. For some applications, RFID tags containing an electronic code are preferred, where the electronic code is programmed into the memory of the chip of the RFID device and is read with an electronic reader. For other applications, tags including visual and electronic information are preferred.

In all tags referred above, the code is required to be well printed and visible. A good contrasting mark is required, usually black, in which good visibility from a distance of several meters to the animals is required. Good contrast is essential as the reading is often done from a distance, and good durability of the marking is mandatory as the tags are exposed to UV and harsh outdoor conditions for the entire life of the animal, which in some cases (dairy applications) can be up to ten years.

The known methods to mark and code animal identification tags are based on laser marking technologies, wherein the tag substrate contains a laser additive and a specific wavelength of light is pulsed on the tags with a pre-determined frequency, to generate the visual information.

Methods based on laser marking are preferred because they provide long term UV and mechanical stability. Considering that, in some countries, the animals spend most of the year outdoors, good light stability of the marking is required along with mechanical resistance due to abrasion resulting from contact with other animals, etc.

However, laser marking methods exhibit limitations especially due to the fact that they generates a dark grey color, and not exhibiting an optimal contrast to the background color, and thus are not optimized to be read from a long distance from the animal.

Moreover, laser marking methods require longer production time and thus the manufacturer usually chooses a compromise between the contrast of the laser mark and production speed, which finally ends in a further decrease of the quality of the visual information.

Other known methods to mark the tags are based on digital printing, using binary printing technology. The binary printing allows for high printing throughput and a good contrasting black printing. However, the light fastness of the ink is inadequate and limiting the animal tag lifetime to maximum of two years, which is often less than the animal's lifetime. Thus, digital printing is adapted to print short term animal tags, for instance for animals bred for meat production, where the animal has a typical lifetime of 1.5 to 2 years. With this technique, a solvent-based ink composed of soluble colorants is used. This ink has low light fastness properties and limited adhesion to the polymeric tag surface but for short term tags where the animal has a short life span, the limited light fastness and mechanical resistance is sufficient and equivalent to the lifetime of the animal and its accompanying ID tag.

Some animal tags, for instance used for identification of animals bred for milk and wool production, require good light stability of the marking along with mechanical resistance, as provided by laser marking, but at the same time good contrasting black marking as provided by the digital printing.

A known method to improve durability and contrast of laser marking on animal tags is based on two main phases, i.e. a laser marking of visual information followed by an over marking of the same information with laser ink printing, i.e. an electrostatic digital printing process where text and graphics are printed by repeatedly passing a laser beam back and forth over an electron-charged, cylindrical drum, to define a differentially-charged image. The drum selectively collects electrically-charged, powdered ink (i.e. toner), and transfers the image to the substrate to be printed, which is heated in order to permanently fuse the text/imagery.

Even the methods mentioned here above introduce some improvement and provide a better contrasting black with respect to the basic laser marking, they suffer for other disadvantages due to high production costs and time. Indeed, this method involves heating followed by laser marking and then followed by laser printing, with various iterations of these processes.

The problem at the base of the present invention is that of providing a method to mark animal tags with visual information having good contrast and readability also at a distance from the animal, at the same time a good resistance to atmospheric conditions, including UV, water, humidity, harsh conditions, etc, but at the same adapted to mark faster, to reduce production costs, to simplify the marking, to further improve readability and contrast, substantially overcoming all the limitations that currently affect the prior art methods for marking animal tags.

### SUMMARY OF THE INVENTION

The applicant has discovered that an animal identification tag can be printed with inkjet printing, using a UV-curable ink wherein color is given by pigments, for instance black pigments, and where the mechanical and light fastness properties can be increased as UV curing of the ink after printing fixes the marking and it becomes part of the polymeric substrate of the tag. UV-curable inks enable combined good black marking with optimized contrast along with improved light and mechanical resistance properties.

The black ink printing and curing may be followed by a layer of varnish to further improve mechanical resistance and also for enhancing the glossy effect and the black contrast. The varnish can be applied with inkjet technologies or with other printing methods, for instance flexography printing. One or more layers of varnish can be applied for enhanced coverage and mechanical protection. The properties of the varnish can be tuned for improved light fastness and flexibility.

According to an aspect of the invention, the ink is printed in Drop-on-Demand (DOD) mode, where only the drops of ink to be printed are generated, the drops being either generated thermally or with piezoelectric charge. Preferably, according to the present invention, purely UV-curable inks with pigments, without water or solvent, are jetted in DOD and cured. The starting materials of the ink and the corresponding pigments can be chosen depending on the polymeric substrate forming the animal tag, in order to improve ink/substrate adhesion. Advantageously, a good black contrast may be achieved combined with good light and mechanical resistance properties.

According to the present invention, UV curing of the ink may be based on two different UV curing processes, i.e. free radical chemistry or cationic curing chemistry.

The UV cure ends and fixes the chemical reaction (cationic or free radical) ensuring high adhesion of the inks to the tag surface.

With free radical chemistry, free radicals are formed by the excitement and breakdown of an initiator; the free radicals react with double bonds in UV curable resins (for instance acrylates) to form chain propagating species; further reaction of these species form polymer chains. Free radical acrylates can soften some plastics in a same way as solvents make (such as MEK) in the solvent based technologies; advantageously, this softening can enhance adhesion of the UV-curable ink to the polymeric substrate of the animal tag, when cured.

With cationic curing chemistry a proton is created by exposure of the system to UV light; reaction of cations with cycloaliphatic epoxies crosslink one with the other, or react with hydroxyl compounds or vinyl ethers. Cationic systems offer chemical bonding to some plastics, for instance where reactive hydroxyl or carboxyl groups exist, and this chemical bonding enhance adhesion of the ink to the polymeric substrate of the animal tag.

On the other hand, cationic systems are sensitive to inhibition by the presence of amines. Free radical systems are not inhibited in the same way as cationic systems and are seen as more robust and versatile.

Both cationic and free radical systems offer a wide range of formulation parameters and work well with dispersed pigments.

Here below is given an example of an ink composition to be used for free radical process, according to the present invention:
a low viscosity acrylate or mixture of acrylates, such as 4-hydroxyl acrylate or Dipropylene glycol diacrylate;
photoinitiators, for instance Irgacure 819 and Darocuur TPO;
sensitizers, for instance as ITX;
pigment suspension;
surfactant, to control surface tension;
polymerization inhibitor, to avoid premature curing;

Similarly, an example of an ink composition to be used for cationic curable process is given here below, according to the present invention:

A cationic curable formulation may be:
photopolymerizable monomers or oligomers, for instance epoxies or vinyl ethers,
optional alcohols or moieties that contain alcohol and epoxide groups;
cationic photoinitiators, for instance as Aryl iodonium salts;
pigment dispersions;
surfactant, to control surface tension;

Both radiation curing systems offer an extensive range of materials to suit particular specifications. The advent of small, UV LED energy sources is opening up the possibilities for use of UV curing technologies. The stability prior to jetting, is seen as an advantage, as is the absence of volatile solvents.

According to the solution idea given above, the technical problem at the base of the invention is solved by a method for printing an animal tag as specified in the claims.

More particularly, the method to print durable and high contrast identification codes, indicia and figures on an animal tag is characterized by printing an ink on a polymeric substrate of the animal tag, the step of printing being executed with inkjet printing technique and the ink being a UV-curable ink including pigments, wherein the ink is UV cured after inkjet printing, becoming integral part of the polymeric substrate.

The step of printing is preferably executed in a drop on demand mode.

The polymeric substrate includes thermoplastics, preferably polyurethane, or nylons, preferably polyamides.

In an aspect of the invention, the UV-curable ink includes a cycloaliphatic epoxy resin, polymerization of the resin is made through a cationic reaction mechanism and the polymerized resin becomes part of the polymeric substrate once cured by either a LED source or medium-pressure mercury lamp.

In another aspect of the invention, UV-curable ink includes epoxy acrylate resin, polymerization of the resin is made through a free radical reaction and the polymerized resin becomes an integral part of the polymeric substrate when UV cured.

In an embodiment of the invention, the polymeric substrate is a thermoplastics or polyurethane based substrate and the UV curable ink is composed of a cycloaliphatic epoxy resin.

In another embodiment, the polymeric substrate is a thermoplastic or polyamide based substrate and the UV curable ink is composed of epoxy acrylate resin.

Preferably, the method according to the invention further includes the steps of mixing a first and a second UV-curable inks, the first ink being adapted to start a cationic reaction on the polymeric substrate, and the second ink being adapted to start a radical reaction on the polymeric substrate, and wherein the mixing of UV-curable inks is made before the inkjet printing and the UV curing. For instance, the first UV-curable ink includes cycloaliphatic epoxy resin and the second UV-curable ink includes epoxy acrylate resin.

A corona discharge treatment on the polymeric substrate may be executed before inkjet printing to prepare the polymeric substrate.

Advantageously, adhesion of the ink to the polymeric substrate of the tag is increased by selecting the characteristics of the pigments in the ink on the base of polymers of the polymeric substrate.

Pigments characteristics to be selected include a percentage of pigments in ink volume 2-3% wt, a pigment size, preferably less than 100 nm, a hue, a saturation, a lightness of the pigment. Preferably, pigments size are in a range of nanometers.

The step of applying a varnish on the substrate may be executed after curing the printed ink. The varnish preferably includes UV stabilizers for improving light fastness.

According to an aspect of the invention, the ink can include dyes but is void of solvent, resin binder, cross linker or adhesion promotors. This is advantageous because, in both water and solvent based technologies, the choice of resin binder is critical and low viscosities required with ink jet links limits the amount of resin. It is critical that there is sufficient resin to adequately bind the pigments.

The absence of solvent, resin binder, cross linker or adhesion promotors in the ink which is UV cured on the polymeric substrate according to the present inventions is also advantageous with respect to other ink technologies, for instance flexographic and gravure, where the properties of water and solvent inks can be enhanced by use of cross linkers or adhesion promotors. Indeed, due to the reactive nature of these materials, they can lead to reduced pot life stability, which is undesired in ink jet applications.

The use of UV curable inks offers a solution to many of the limitations found in water and solvent print technologies. For instance, the UV curable ink is instantaneously cured, very stable in the uncured state (no drying out in nozzle), dangerous solvent emissions are avoided, and it is chemically bond to the plastics.

The step of UV curing includes applying UV light through a UV LED but not excluding other UV drying technologies.

The technical problem mentioned above is also solved by an animal tag derived by the method according to the present invention, in particular an animal tag comprising a polymeric substrate and durable and high contrast identification codes on the polymeric substrate marked using a pigmented UV cured inkjet printed ink.

### DETAILED DESCRIPTION OF THE INVENTION

According to the present invention, a method to print durable and high contrast identification codes, indicia or figures on an animal tag, is provided and based on the following steps, which is here described just to give an example on how the method may be implemented and without limiting the scope of protection of the invention.

The animal tag comprises a plastic substrate, more particularly a polymeric substrate, adapted to be attached to the animal, for instance to an ear of the animal, and to carry on the identification codes, indicia or figures or even barcodes. The information associated to the tag according to the present invention have a good contrast with respect to the underling substrate, are easily detected or read by human operators or an electronic reader, also from a long distance; the same information is durable, at least as long as the life of the animal, and have high resistance to atmospheric agents, such as rain, wind, sun, humidity, maintaining the good contrast also after long exposures to these agents.

According to the method of the present invention, an ink is printed on the polymeric substrate of the animal tag, on a surface of such substrate intended to be exposed to the sight of the operators or to the readers, a substantially flat surface counter posed to another surface adapted to be in contact with the animal's ear or another portion of the animal.

The step of printing the ink is executed with inkjet printing technique. This step forms a digital image by propelling droplets of ink onto the surface of the polymeric substrate and is executed through a printer having a print head adapted to deposit droplets directly on the polymeric substrate surface, through a continuous or, preferably, a Drop-on-demand technique, and according to a digital pattern corresponding to the information to be printed.

Preferably, the polymeric substrate of the animal tag is preliminary treated to improve adhesion of the UV curable ink, for instance through a corona discharge treatment.

The applicant has discovered that a UV-curable ink including pigments, for instance black pigments, is adapted to give a higher contrast and to guarantee a longer durability on the polymeric substrate than other type of inks, for instance inks containing dyes. More particularly, indicia obtained by printing an ink including black pigments, printed with ink jet printing technique on a polymeric substrate having a yellow or white substrate, is more durable and readable, also after long time exposures to atmospherically conditions, than indicia printed on the same polymeric substrate, also having the same color surface, obtained by printing an ink with dyes.

UV-curable inks comprise for example acrylic monomers with an initiator package. The printed ink is cured by exposure to UV-light; a chemical reaction takes place where the photo-initiators cause the ink components to cross-link into a solid on the animal tag. For instance a LED lamp or a shuttered mercury-vapor lamp arranged on either side of a print head produces a great amount of heat to complete the curing process. This lamp may be used for instance for a free radical process to cure the UV ink.

Curing processes with high power for short periods of times (microseconds) allow curing inks on thermally sensitive substrates. Advantageously, UV curable inks do not evaporate but rather cure or set as a result from a chemical reaction, and about 100% of the delivered ink is used to provide coloration, very quickly. This allows a very fast print process of the animal tags, increasing the through put.

Indeed, advantageously, UV-curable inks dry as soon as they are cured and they produce a very robust visual image (text or figure or bar code, etc) on the animal tag.

According to the present invention, durability of the indicia on the polymeric substrate is further increased by selecting an ink with pigments which become part of the deposited ink layer, curing the ink after inkjet printing on the polymeric substrate surface fixes the ink layer to the polymeric surface of the tag. The effect of the UV cure is integrating the printed ink on the polymeric substrate, i.e. strengthening the link between the ink and polymeric substrate, at least in the region of the surface of the polymeric surface. This structure is adapted to resist for long time to the sun, to the rain, wind, humidity but also to rubbing of the polymeric surface against other surfaces, since the ink pigment corresponding to the indicia are integrally connected to the surface of the animal tag.

The pigment is solid and changes the color of reflected or transmitted light as the result of wavelength-selective absorption. The pigments have special properties that make them ideal for coloring the polymeric substrate of the animal tag. The pigment is selected to have a high tinting strength relative to the polymeric substrate it colors, and to be stable in solid form at ambient temperatures, more particularly at the outside temperatures of the environment in which the animal live. Preferably the pigments are carbon-based, for instance made from soot. Advantageously, the carbon particles do not fade over time even when in sunlight and are chemically stable.

The pigment characteristics of the pigments included in the ink are selected on the base of polymers of the polymeric substrate. Pigments characteristics to be selected include a percentage of pigments in ink volume 2-3% wt, a pigment size preferably less than 100 nm or in the range of nanometers, a hue, a saturation, a lightness of the pigment.

According to another aspect of the invention, the polymeric substrate of the animal tag may include thermoplastics, preferably polyurethane, or nylons, preferably polyamides.

In an embodiment of the invention, the UV-curable ink includes a cycloaliphatic epoxy resin, and polymerization of the cycloaliphatic epoxy resin is made through a cationic reaction, this reaction being controlled by the printer, when the UV-curable ink is printed on the polymeric substrate. The polymerized resin becomes part of the polymeric substrate once cured, for instance by either a LED source or medium-pressure mercury lamp.

In another embodiment of the invention, the UV-curable ink includes epoxy acrylate resin, polymerization of the resin is made through a free radical reaction and the polymerized resin becomes an integral part of the polymeric substrate when UV cured.

Concerning the animal tag polymeric substrate different material may be used and the UV curable ink selected on the base of the material of the polymeric substrate. For instance, a thermoplastics or nylon based substrate may be used for the animal tag and, in this case, a UV curable ink composed of a cycloaliphatic epoxy resin presents high adhesion properties.

Differently, when the polymeric substrate of the animal tag is a thermoplastic or polyamide, the UV curable ink is preferred to be composed of epoxy acrylate resin to provide high adhesion on the animal tag substrate surface.

The applicant has also identified possible mixture of different UV curable ink adapted to be applied on the animal tag with a corresponding chemical reaction. A first and a second UV-curable inks may be mixed, the first ink being adapted to start a cationic reaction on the polymeric substrate, and the second ink being adapted to start a radical reaction on the polymeric substrate, and wherein said mixing of UV-curable inks is made before said inkjet printing and UV curing. The UV cure ends and fixes the chemical reaction (cationic or free radical) ensuring high adhesion of the inks to the tag surface. For instance, the first UV-curable ink includes cycloaliphatic epoxy resin and the second UV-curable ink includes epoxy acrylate resin.

A step of applying a varnish on the polymeric substrate, after curing the printed ink, is preferably executed to further enhance adhesion properties of the ink to the tag and its color contrast and readability. The varnish may include UV stabilizers for improving light fastness.

The main advantages of the present invention are briefly resumed here below. The method for printing indicia on the animal tag guarantees a durability of the indicia, a contrast and a resistance to harsh which is definitely increased with respect to durability, contrast and resistance in known laser technique or digital printing techniques commonly used to print on the animal tags.

The method is a great alternative to more sophisticated and expensive technologies based on laser marking combined with heating and laser overprinting and, at the same time, reduces the manufacturing time due to the speed at which the UV curable ink dry on the polymeric surface of the tag, through UV cure, in absence of solvent or water.

Advantageously, in the method to print animal tag, no resin binders, cross linkers, adhesion promotors, solvents or other material commonly necessary in other printing techniques are used, avoiding dangerous solvents emissions and requesting the cost and complexity of the process and the corresponding animal tag.

1. A method to print durable and high contrast identification codes, indicia and figures on an animal tag, characterized by printing an ink on a polymeric substrate of said animal tag, said step of printing being executed with inkjet printing technique and said ink being a UV-curable ink including pigments, wherein the ink is UV cured after inkjet printing, becoming integral part of the polymeric substrate.

2. The method according to claim 1, wherein the step of printing is executed in a drop on demand mode.

3. The method according to claim 1, wherein the polymeric substrate includes thermoplastics, preferably polyurethane, or nylons, preferably polyamides.

4. The method according to claim 1, wherein the UV-curable ink includes a cycloaliphatic epoxy resin, polymerization of the resin is made through a cationic reaction mechanism and the polymerized resin becomes part of the polymeric substrate once cured by either a LED source or medium-pressure mercury lamp.

5. The method according to claim 1, wherein the UV-curable ink includes epoxy acrylate resin, polymerization of the resin is made through a free radical reaction and the polymerized resin becomes an integral part of the polymeric substrate when UV cured.

6. The method according to claim 3, wherein the polymeric substrate is a thermoplastics or polyurethane based substrate and the UV curable ink is composed of a cycloaliphatic epoxy resin.

7. The method according to claims 3, wherein the polymeric substrate is a thermoplastic or polyamide and the UV curable ink is composed of epoxy acrylate resin.

8. The method according to claim 1, further including the steps of mixing a first and a second UV-curable inks, the first ink being adapted to start a cationic reaction on the polymeric substrate, and the second ink being adapted to start a radical reaction on the polymeric substrate, and wherein said mixing of UV-curable inks is made before said inkjet printing and said UV curing.

9. The method according to claim 8, wherein the first UV-curable ink includes cycloaliphatic epoxy resin and the second UV-curable ink includes epoxy acrylate resin.

10. The method according to claim 1, characterized by further including a corona discharge treatment on said polymeric substrate, said corona discharge treatment being applied before inkjet printing.

11. The method according to claim 1, wherein the pigment characteristics of the pigments included in the ink are selected on the base of polymers of said polymeric substrate.

12. The method according to claim 1, wherein pigments characteristics to be selected include a percentage of pigments in ink volume 2-3% wt, a pigment size preferably less than 100 nm, a hue, a saturation, a lightness of the pigment.

13. The method according to claim 1, wherein pigments are black.

14. The method according to claim 1, wherein pigments size are in a range of nanometers.

15. The method according to claim 1, including the step of applying a varnish on the substrate, the varnish being applied after curing the printed ink.

16. The method according to claim 1, wherein the varnish includes UV stabilizers for improving light fastness.

17. The method according to claim 1 wherein the ink is void of solvent, dyes, resin binder, cross linker or adhesion promotors.

18. The method according to claim 1 wherein said step of UV curing include applying UV light through a UV LED.

19. The method according to claim 1 wherein the animal tag is an animal ear tag.

20. An animal tag comprising a polymeric substrate and durable and high contrast identification codes on the polymeric substrate marked using a pigmented UV cured inkjet printed ink.

21. The animal tag according to claim 20, wherein the UV curable ink include pigments of black color.

22. The animal tag according to claim 21, wherein the pigment of black color is carbon black.
